(19) United States
(12) Patent Application Publication
(10) Pub. No.: US 2011/0182138 A1
(43) Pub. Date: Jul. 28, 2011

(54) Method and system for streamer depth control

(76) Inventors: Gustav Göran Mattias Südow, Vallingby (SE); Ulf Peter Lindqvist, Segeltorp (SE); Andras Robert Juhasz, Hagersten (SE)

(21) Appl. No.: 12/657,831

(22) Filed: Jan. 28, 2010

(51) Int. Cl. G01V 1/38

(52) U.S. Cl. 367/16

(57) ABSTRACT

A depth and level control system for a geophysical streamer according to one aspect of the invention includes a plurality of tilt sensors disposed at spaced apart locations along the streamer. The tilt sensors each have a first tilt sensing element arranged to measure tilt of the streamer along a longitudinal dimension thereof. A controller is in signal communication with each tilt sensor. A depth control device is in signal communication with each controller. The controller is programmed to operate the depth control device to cause the streamer to be level as measured by the tilt sensor.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of marine geophysical surveying.

More particularly, the invention relates to devices and methods for controlling the depth of marine geophysical sensor streamers as they are towed in a body of water.

2. Background Art

Certain types of marine geophysical surveying, such as seismic surveying include towing an energy source at a selected depth in a body of water. One or more geophysical sensor streamers are towed in the water at selected depths. The streamers are essentially long cables having geophysical sensors disposed thereon at spaced apart locations. Actuation of the energy source emits an energy field into the body of water. The energy field interacts with the rock formations below the water bottom. Reflected energy from interfaces, generally at the boundaries between layers of rock formations, is returned toward the surface and is detected by the sensors on the one or more streamers. The detected energy is used to infer certain properties of the subsurface rock formations, such as structure, mineral composition and fluid content.

For certain types of surveying, it is important that the streamers are maintained as closely as possible to the selected depth in the water. Devices known in the art used for such purpose include “lateral force and direction” (LFD) control devices. U.S. Pat. No. 6,144,342 issued to Bertheas et al. describes a structure for LFD control devices and a method for controlling the navigation of a towed seismic streamer using “birds” affixable to the exterior of the streamer. The birds are equipped with variable-incidence wings and are rotatably fixed onto the streamer. Through a differential action, the wings allow the birds to be turned about the longitudinal axis of the streamer so that a hydrodynamic force oriented in any given direction about the longitudinal axis of the streamer is obtained. Power and control signals are transmitted between the streamer and the bird by rotary transformers. The bird is fixed to the streamer by a bore closed by a cover. The bird can be detached automatically as the streamer is raised so that the streamer can be wound freely onto a drum. The disclosed method purportedly allows the full control of the deformation, immersion depth and heading of the streamer.

In using such LFD control devices to maintain the streamer at a selected depth, sensors are required to be positioned along the streamer that generate a signal related to depth. Pressure sensors are typically used for depth measurement. Typical pressure sensors used in geophysical surveying can be calibrated to a precision of about 0.1 percent of the full scale range of the sensor. At a water depth of 1000 meters, a streamer using only pressure sensors for depth measurement can be navigated to be horizontal in the water to a precision of 1 meter. At correspondingly greater water depths, the possible error in navigation of the streamer in the vertical plane becomes proportionately larger.

What is needed is a system that can assist in navigation of a geophysical sensor streamer in the vertical plane at relatively great water depth.

### SUMMARY OF THE INVENTION

A depth and level control system for a geophysical streamer according to one aspect of the invention includes a plurality of tilt sensors disposed at spaced apart locations along the streamer. The tilt sensors each have a first tilt sensing element arranged to measure tilt of the streamer along a longitudinal dimension thereof. A controller is in signal communication with each tilt sensor. A depth control device is in signal communication with each controller. The controller is programmed to operate the depth control device to cause the streamer to be level as measured by the tilt sensor.

A method for depth control of a marine geophysical streamer according to another aspect of the invention includes towing the streamer in a body of water. Tilt is measured at a plurality of spaced apart locations along the streamer in a direction along the longitudinal dimension of the streamer. The streamer is deflected in the vertical plane proximate each location of measuring tilt such that the streamer is substantially level at each location.

Other aspects and advantages of the invention will be apparent from the following description and the appended claims.

### BRIEF DESCRIPTION OF THE DRAWINGS

FIG. 1 shows an example geophysical survey system with a streamer having depth and tilt sensor modules.

FIG. 2 shows more detail of an example of one of the modules shown in FIG. 1.

### DETAILED DESCRIPTION

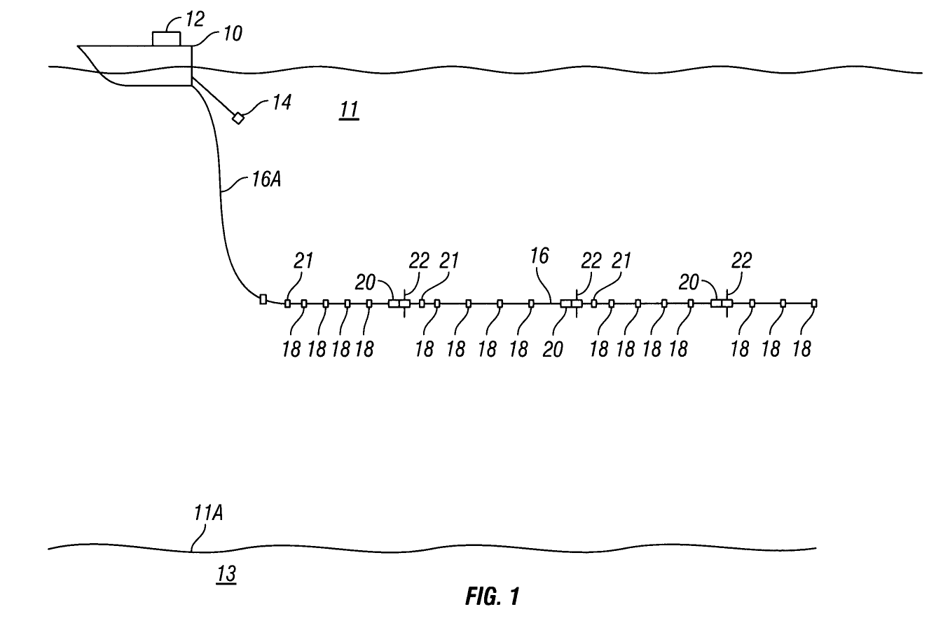

An example marine geophysical survey system is shown schematically in FIG. 1.

The system may include a survey and towing vessel 10 that moves along the surface of a body of water 11 such as a lake or the ocean. The vessel 10 includes thereon equipment, shown generally at 12 and for convenience referred to herein as a “recording system.” The recording system 12 may include devices (none shown separately) for determining geodetic position of the vessel (e.g., a global positioning system satellite signal receiver), for detecting and making a time indexed record of signals generated by each of a plurality of geophysical sensors 18 (explained further below), and for actuating an energy source 14 at selected times. The energy source 14 may be any selectively actuatable source used for subsurface geophysical surveying, including without limitation seismic air guns, water guns, vibrators or arrays of such devices, or one or more electromagnetic field transmitters.

In the present example, the geophysical sensors 18 may be disposed at spaced apart locations along a streamer cable 16. A non-limiting example of a structure for a geophysical sensor streamer cable is described in U.S. Pat. No. 7,298,672 issued to Tenghamn et al. and commonly owned with the present invention. The streamer cable 16, as explained above, includes a plurality of spaced apart geophysical sensors 18 along its length. The sensors may be, without limitation, seismic sensors such as geophones, hydrophones and accelerometers, electromagnetic field sensors such as electrodes magnetic field sensors or magnetometers. The sensors 18 may generate electrical and/or optical signals in response to detecting energy emitted from the source 14 after the energy has interacted with rock formations 13 below the water bottom 11A. The streamer cable 16 may be connected directly to the vessel 10 using a lead in line 16A to communicate power and signals between the recording unit 12 and the various electronic components in the streamer 16. The lead in line 16A may also transmit towing force from the vessel 10 to the streamer 16.

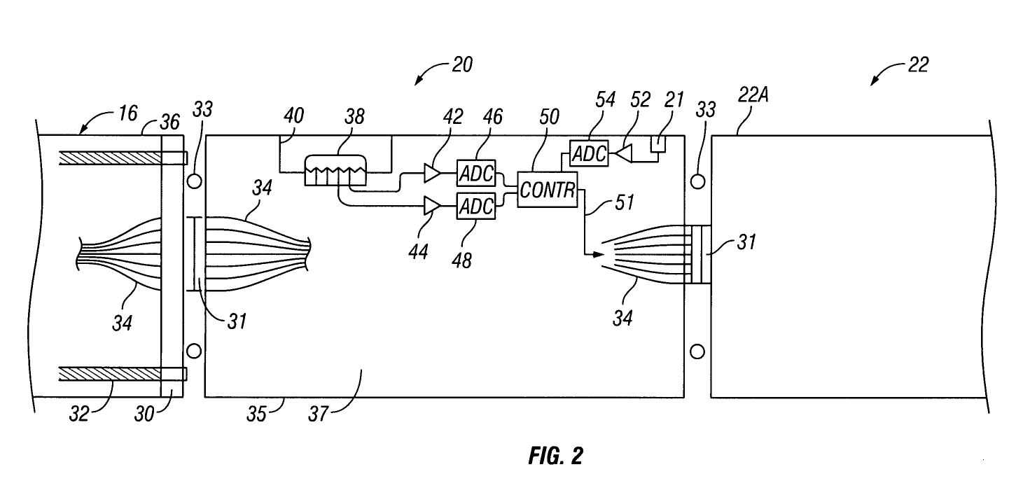

The streamer cable 16 is typically formed by connecting a plurality of streamer segments end to end as explained in U.S. Pat. No. 7,142,481 issued to Metzbower et al. and commonly owned with the present invention. The streamer segments are coupled by assembling corresponding termination plates (FIG. 2) at each end of each streamer segment. In the present example, at selected couplings between streamer segments, the streamer may include an LFD control device 22 and an associated tilt and depth sensor module 20. One example of an LFD control device that is coupled between streamer segments is described in U.S. Patent Application Publication No. 2008/0192570 filed by Tenghamn et al. and commonly owned with the present invention. U.S. Pat. No. 6,144,342 issued to Bertheas et al. describes another structure for LFD control devices that may be coupled between streamer segments. The tilt and depth sensor module 20 will be further explained with reference to FIG. 2. The tilt and depth sensor module 20 may couple between streamer segments as shown in FIG. 1. Although the present example is described as using LFD devices capable of navigating the streamer in both the horizontal and vertical planes, for purposes of the invention, it is only necessary to have one or more devices along the streamer which can navigate the streamer in the vertical plane. It should also be noted that while the present example shows only one streamer, the invention is applicable to any number of laterally spaced apart streamers towed by the survey vessel 10 or any other vessel.

The streamer 16 may also include a plurality of pressure sensors 21 disposed at spaced apart positions along the length of the streamer. The pressure sensors 21 are configured to measure pressure in the water 11, which will provide an approximate indication of the depth of the streamer 16 in the water at the position of each pressure sensor 21. In the example explained below with reference to FIG. 2, the pressure sensors 21 may each be disposed in one of the modules 20.

FIG. 2 shows schematically an example of one of the tilt and depth sensor modules 20. The module 20 may include a pressure sealed, high strength housing 35. The material used for the housing should be able to withstand hydrostatic pressure of the water at the maximum intended operating depth of the streamer 16. The housing 35 may be generally cylindrically shaped, may be approximately the same external diameter as the streamer, and may include at each of its longitudinal ends an electrical/optical connector 31 to enable electrical and/or optical connection between individual conductors and/or optical fibers in a wire harness 34 that extends along the length of the streamer 16. The housing 35 may defined a sealed interior chamber 37 generally at atmospheric pressure. As explained above with reference to FIG. 1, the streamer 16 is typically assembled from segments, each segment being about 75 to 100 meters in length. The segments can be joined end to end by including a termination plate 30 at the longitudinal ends of each segment. Strength members 32, which extend along the length of each segment may be affixed to the termination plate 30 to enable transmission of axial loading between segments, or between a segment coupled to one of the modules 20 as shown in FIG. 2. The electrical/optical connector 31 may be sealed against water intrusion by o-rings 33 or similar seal disposed externally to the electrical/optical connector 31. Certain of the conductors in the wire harness 34 may provide electrical power to the various components in the module 20 as will be explained below. The termination plate 30 may be conventionally configured to be coupled to another termination plate on another streamer segment. In the present example, the housing 35 may be configured to coupled to the termination plate 30 in the same manner as to another termination plate to simplify assembly of the streamer 16.

A tilt sensor 38 may be mounted in a gimbal bearing frame 40 to the interior of the housing 35. The tilt sensor 38 is mounted in the frame 40 so that it remains substantially vertically oriented notwithstanding twisting of the streamer 16 during operation. The tilt sensor 38 may measure tilt along only one direction, and in such examples, the direction is along the longitudinal dimension of the streamer. In other examples, the tilt sensor 38 may measure tilt along such dimension and in a direction orthogonal to the longitudinal dimension of the streamer. In one example, the tilt sensor 38 can be an electrolytic bubble level type such as one made by Spectron, Inc., Hauppage N.Y. sold under model designation SP500. The purpose for a two-axis tilt sensor will be explained below. Another example is a micro-electrical-mechanical system (MEMS) tilt sensor sold by RST Instruments, 200-2050 Hartley Avenue, Coquitlam, British Columbia, Canada. Electrical output of the tilt sensor 38 may be conducted to a first preamplifier 42, the output of which may be digitized in a first analog to digital converter (ADC) 46. Output of the first ADC 46 may be conducted to a microcontroller 50. A signal output of the microcontroller, shown as line 51, may be conducted to the LFD device 22 coupled adjacent to the tilt and depth sensor module 20. If a two-axis tilt sensor is used, output of the second signal channel of such sensor may be conducted to a second preamplifier 44, the output of which may be digitized in a second ADC 48. The output of the second ADC 48 may be conducted to the microcontroller. In the example shown in FIG. 2, one of the pressure sensors 21 may be mounted in the housing. Output of the pressure sensor 21 may be amplified in a third preamplifier 52 and digitized in a third ADC 54 before being conducted to the microcontroller 50.

The other longitudinal end of the housing 35 may be coupled to one end of the housing 22A of the LFD device 22 in a manner similar to the coupling of the streamer segment termination plate 30 to the opposite end of the housing 35. Such coupling may include electrical/optical connectors 31 substantially as explained above with reference to the connection between the streamer segment and the housing 35.

Functional parts of the LFD device are omitted from FIG. 2 for clarity of the illustration, however, the principle of operation of the tilt and depth sensor module 20 with respect to the LFD device 22 is as follows. If the tilt sensed by the tilt sensor 38 along the streamer length is toward the aft end of the streamer (away from the vessel 10 in FIG. 1), then the microcontroller 50 generates a control signal to cause the LFD device 22 to generate upward force, thus lifting the portion of the streamer proximate the LFD device 22 and the module 20. Conversely, if the tilt measured along the streamer length is toward the front end of the streamer, the microcontroller 50 may generate a control signal to cause the LFD device to generate downward force. When the tilt sensor 38 measures zero tilt (or tilt below a selected threshold) along the length of the streamer, the microcontroller 50 may generate a signal to cause the LFD device 22 to generate no upward or downward force.

As explained in the Background section herein, pressure sensors known in the art for streamer depth control have accuracy of about 0.1% of full scale. However, the resolution of such sensors can provide depth resolution on the order of 0.1 meter. In another aspect of the invention, pressure measurements made by the pressure sensor 21 in each module 20 can be communicated over a conductor in the wire harness 34 from the controller 50 to the controller in each of the other modules in the streamer. The controller 50 may include programming instructions to send a control signal to the associated LFD device to either raise or lower the streamer until the pressure measurements made by each pressure sensor are substantially equal, or differ from each other by at most a selected threshold. By matching depths, and levelling the measured tilt, the entire streamer may be maintained substantially in a straight, horizontal line.

In examples where a two-axis tilt sensor is used, the second axis signal may be used as a discriminator. If the tilt measured orthogonal to the length of the streamer is above a selected threshold, for example, the microcontroller 50 may be programmed not to generate a control signal to operate the LFD device 22, or may generate a signal to cause the LFD device 22 to generate no upward or downward force. In such cases, the tilt sensor 38 may not be oriented vertically, and measurements of tilt along the length of the streamer may be inaccurate. Thus, tilt measurements along the streamer length in such cases may be treated as the streamer being level.

A depth and level control system according to the invention may enable more precise control of depth along an entire streamer in water depths for which the accuracy of pressure measurements is insufficient.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A depth and level control system for a geophysical streamer, comprising:
a plurality of tilt sensors disposed at spaced apart locations along the streamer, the tilt sensors each having a first tilt sensing element arranged to measure tilt of the streamer along a longitudinal dimension thereof;
a controller in signal communication with each tilt sensor; and
a depth control device in signal communication with each controller, the controller programmed to operate the depth control device to cause the streamer to be level as measured by the tilt sensor.

2. The system of claim 1 wherein each tilt sensor is an electrolytic bubble level sensor.

3. The system of claim 1 wherein each tilt sensor is a micro-mechanical-electrical system tilt sensor.

4. The system of claim 1 wherein each tilt sensor is mounted in a gimbal bearing frame such that each tilt sensor is maintained in substantially vertical orientation.

5. The system of claim 4 wherein each tilt sensor further comprises a second tilt sensing element arranged to measure tilt in a direction orthogonal to the first tilt sensing element, the second sensing element in signal communication with a respective one of the controllers.

6. The system of claim 5 wherein each controller is configured not to operate the respective depth control device when the respective second tilt sensing element indicates the tilt sensor is oriented other than substantially vertically.

7. The system of claim 1 further comprising a pressure sensor in signal communication with each controller, and wherein each controller is configured to operate the respective depth control device so that pressures measured by each pressure sensor are within a selected threshold difference.

8. A method for depth control of a marine geophysical streamer, comprising:
towing the streamer in a body of water;
measuring tilt at a plurality of spaced apart locations along the streamer in a direction along the longitudinal dimension of the streamer;
deflecting the streamer in the vertical plane proximate each location of measuring tilt such that the streamer is substantially level at each location.

9. The method of claim 8 further comprising measuring pressure in the water proximate each location of measuring tilt and deflecting the streamer in the vertical plane such that the measured pressures differ by at most a selected threshold.

10. The method of claim 8 wherein the measuring of tilt is performed substantially in the vertical plane.

11. The method of claim 10 further comprising measuring tilt in a direction orthogonal to the longitudinal dimension of the streamer, and disabling deflecting the streamer if the tilt measured in the orthogonal direction is above a selected threshold.
